(19) United States
(12) Patent Application Publication
(10) Pub. No.: US 2013/0265581 A1
(43) Pub. Date: Oct. 10, 2013

(54) System and Method for Measuring Phase-Matching Spectral Phase Curve by Nonlinear Optical Spectral Interferometry

(71) Applicant: NATIONAL TSING HUA UNIVERSITY, Hsinchu (TW)

(72) Inventor: Shang-Da YANG, Hsinchu City (TW)

(73) Assignee: NATIONAL TSING HUA UNIVERSITY, HSINCHU (TW)

(21) Appl. No.: 13/649,129

(22) Filed: Oct. 11, 2012

(30) Foreign Application Priority Data
Apr. 10, 2012 (TW) 101112643

(51) Int. Cl. G01J 3/45

(52) U.S. Cl. 356/451

(57) ABSTRACT

A system for measuring a phase-matching spectral phase curve by nonlinear spectral interferometry includes a broadband light source, a first beam splitter, a first nonlinear crystal, a second nonlinear crystal and a spectrometer. The first beam splitter splits the broadband light source into a first light and a second light. The first nonlinear crystal is used for converting the first light into a third light, wherein the third light has a reference phase spectrum. The second nonlinear crystal is used for converting the second light into a fourth light which encoded a phase-matching spectral phase of the second nonlinear to crystal. The spectrometer is used for providing an interferogram from an interference between the third light and the fourth light. Thus, by analyzing the interferogram, the phase-matching spectral phase curve of the second nonlinear crystal can be measured without knowing the spectral phase of the broadband light source.

### RELATED APPLICATIONS

The application claims priority to Taiwan Application Serial Number 101112643, filed Apr. 10, 2012, which is herein incorporated by reference.

### BACKGROUND

1. Technical Field

The present invention relates to a nonlinear optical technique. More particularly, the present invention relates to a system for measuring a phase-matching spectral phase curve by nonlinear optical spectral interferometry.

2. Description of Related Art

Quasi-phase matching (QPM) has been extensively used in wavelength conversion processes. Different conversion efficiency and specific phase distributions are obtained by a wavelength conversion process through an artificial structure designed in a nonlinear crystal. Under a current technology, the spectrum of conversion efficiency can be measured by a wavelength-tunable CW (continuous wave) laser, but the spectral phase of the nonlinear conversion process can only be calculated in two ways (1) assuming a spatial distribution of the nonlinear coefficient and the dispersion of the crystal, or (2) measuring the optical fields of the input pulse at the fundamental band and the output pulse at the second-harmonic band, respectively. However, the first method could be inaccurate due to the mismatch between the designed and fabricated QPM gratings as well as the error of dispersion formula obtained by data fitting (especially when the converted wavelengths are close to the absorption band of the nonlinear crystal). Besides, the second method needs two nonlinear conversion processes, which is complicated and insensitive.

### SUMMARY

According to one aspect of the present disclosure, a system for measuring a phase-matching spectral phase curve by nonlinear optical spectral interferometry includes a broadband light source, a first beam splitter, a first nonlinear crystal, a second nonlinear crystal and a spectrometer. The first beam splitter splits the broadband light source into a first light and a second light. The first nonlinear crystal converts the first light into a third light, wherein the third light has a reference phase spectrum. The second nonlinear crystal converts the second light into a fourth light, wherein the phase-matching spectral phase of the second nonlinear crystal is encoded in the phase spectrum of the forth light. The spectrometer receives the third light and the fourth light, and provides an interferogram from an interference between the third light and the fourth light.

According to another aspect of the present disclosure, a method for measuring a spectral phase by nonlinear optical phase-matching includes the following steps. A broadband light source is split into a first light and a second light. The first light is converted into a third light through a first nonlinear crystal, wherein the third light has a reference spectral phase. The second light is converted into a fourth light through a second nonlinear crystal, wherein a phase-matching spectral phase of the second nonlinear crystal is encoded in a phase spectrum of the forth light. An interferogarm is formed from the interference between the third light and the fourth light and measured by a spectrometer, wherein the third light and the fourth light propagate in the same direction.

### BRIEF DESCRIPTION OF THE DRAWINGS

The present disclosure can be more fully understood by reading the following detailed description of the embodiment, with reference made to the accompanying drawings as follows:

FIG. 1 is a flowchart showing a method for measuring a phase-matching spectral phase curve by nonlinear optical spectral interferometry according to one embodiment of the present disclosure;

FIG. 2 is a schematic diagram of a system for measuring phase-matching spectral phase curve by nonlinear optical spectral interferometry according to another embodiment of the present disclosure;

FIG. 3 shows phase-matched spectral phases and a phase-matched power spectrum of one example; and

FIG. 4 shows phase-matched spectral phases and a phase-matched power spectrum of another example.

### DETAILED DESCRIPTION

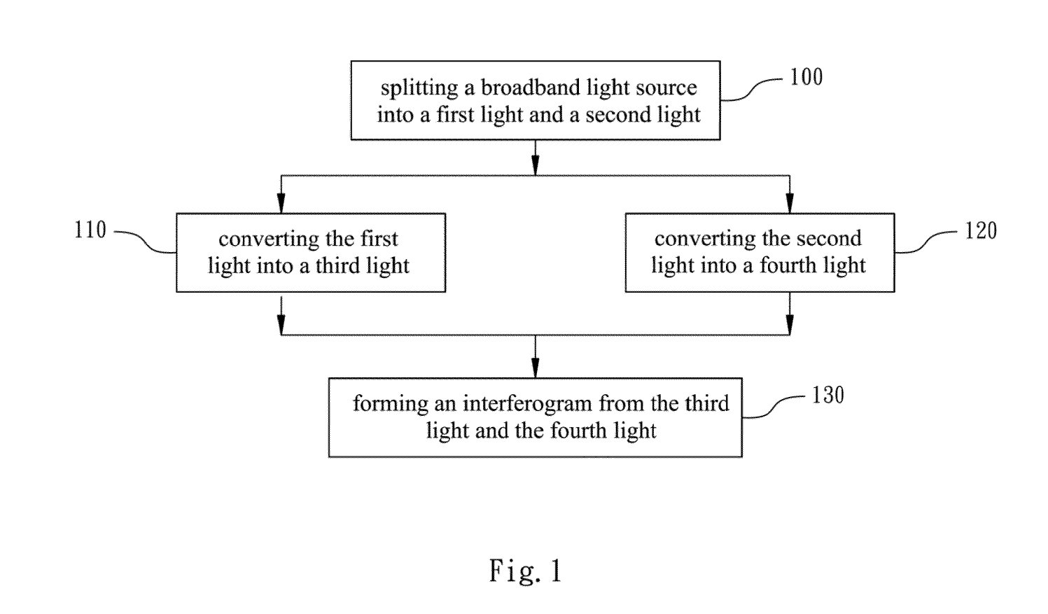

FIG. 1 is a flowchart showing a method for measuring a phase-matching spectral phase curve by nonlinear optical spectral interferometry according to one embodiment of the present disclosure. In FIG. 1 the method includes the following steps. In step 100, a broadband light source is split into a first light and a second light. In step 110, the first light is converted into a third light through a first (reference) nonlinear crystal, wherein the third light has a reference spectral phase. In step 120, the second light is converted into a fourth light through a second (target) nonlinear crystal, wherein a phase-matching spectral phase of the second nonlinear crystal is encoded in a phase spectrum of the forth light. In step 130, an interferogram is provided by a spectrum from an interference between the third light and the fourth light, wherein the third light and the fourth light propagate in the same direction.

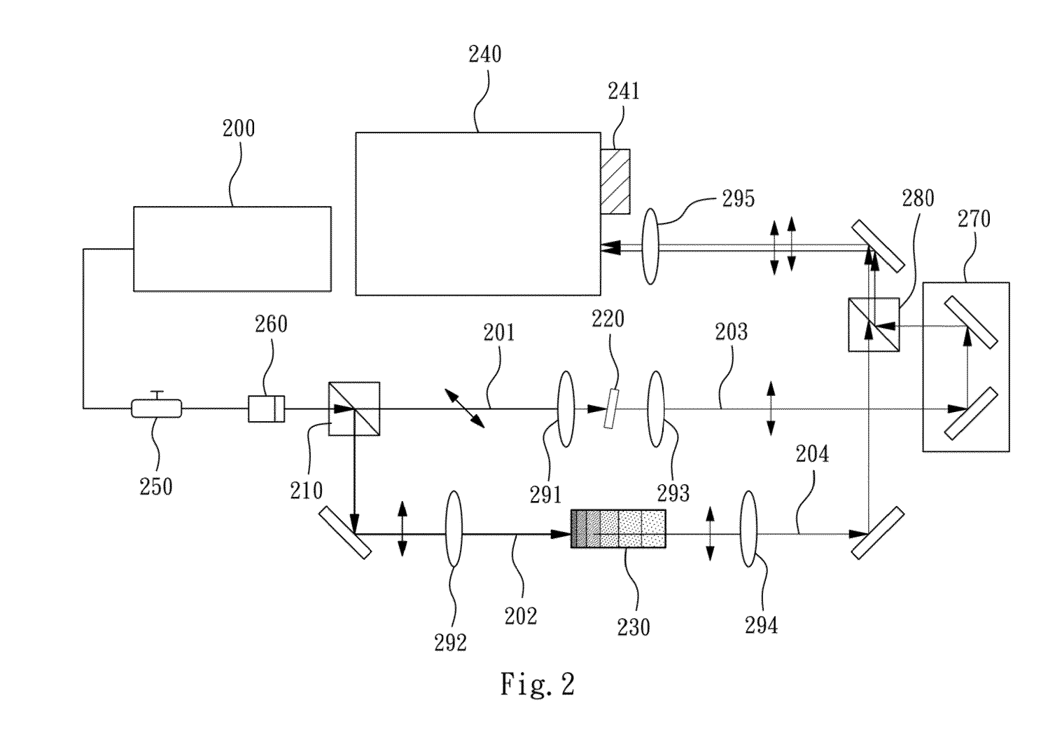

FIG. 2 is a schematic diagram of a system for measuring a phase-matching spectral phase curve by nonlinear optical spectral interferometry according to another embodiment of the present disclosure, wherein the method shown in FIG. 1 can be performed by the system of FIG. 2. In FIG. 2, the system for measuring a spectral phase by nonlinear optical phase-matching includes a broadband light source 200, a first beam splitter 210, a first (reference) nonlinear crystal 220, a second (target) nonlinear crystal 230 and a spectrometer 240. The first beam splitter 210 splits the broadband light source 200 into a first light 201 and a second light 202. The first nonlinear crystal 220 converts the first light 201 into a third light 203, wherein the third light 203 has a reference spectral phase. The second nonlinear crystal 230 converts the second light 202 into a fourth light 204, wherein the phase-matching spectral phase of the second nonlinear crystal 230 is encoded in a phase spectrum of the forth light 204. The spectrometer 240 receives the third light 203 and the fourth light 204, and provides an interferometry spectrum from an interference between the third light 203 and the fourth light 204.

In detail, the system further includes a polarization controller 250 and a collimator 260 which are located between the broadband light source 200 and the first beam splitter 210 in order. The power ratio of the first light 201 and the second light 201 can be controlled by the polarization controller 250 and when the broadband light source 200 has a fiber output, the collimator 260 can make the output light as a beam without quick divergence.

In FIG. 2, the first beam splitter 210 is a polarization beam splitter which can split an incident light into a transmitted light and a reflected light. That is, the broadband light source 200 is split into the first light 201 and a second light 202.

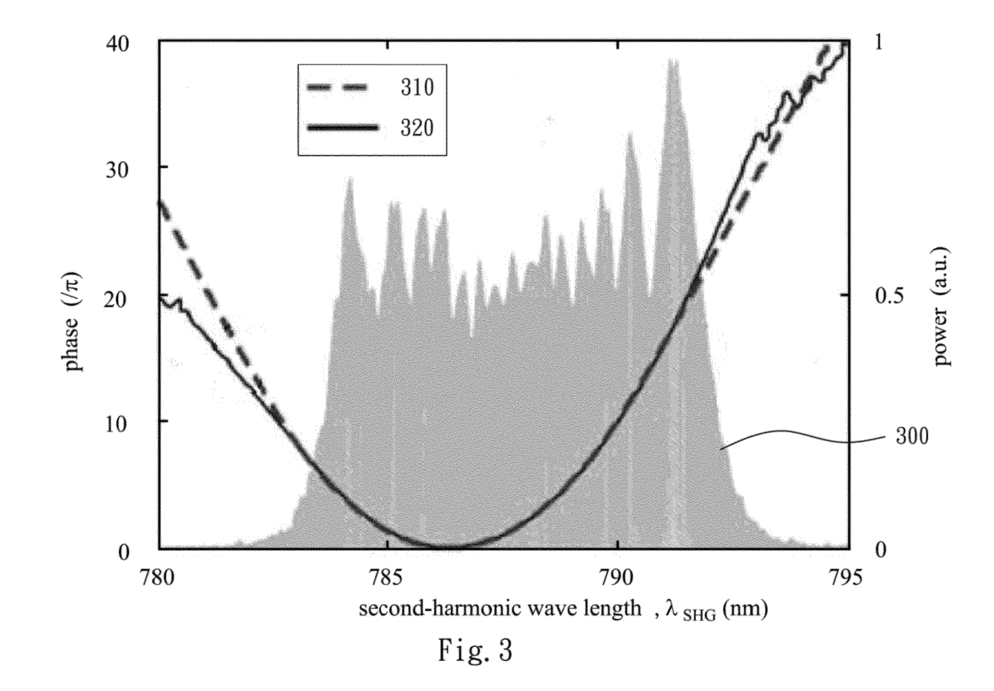

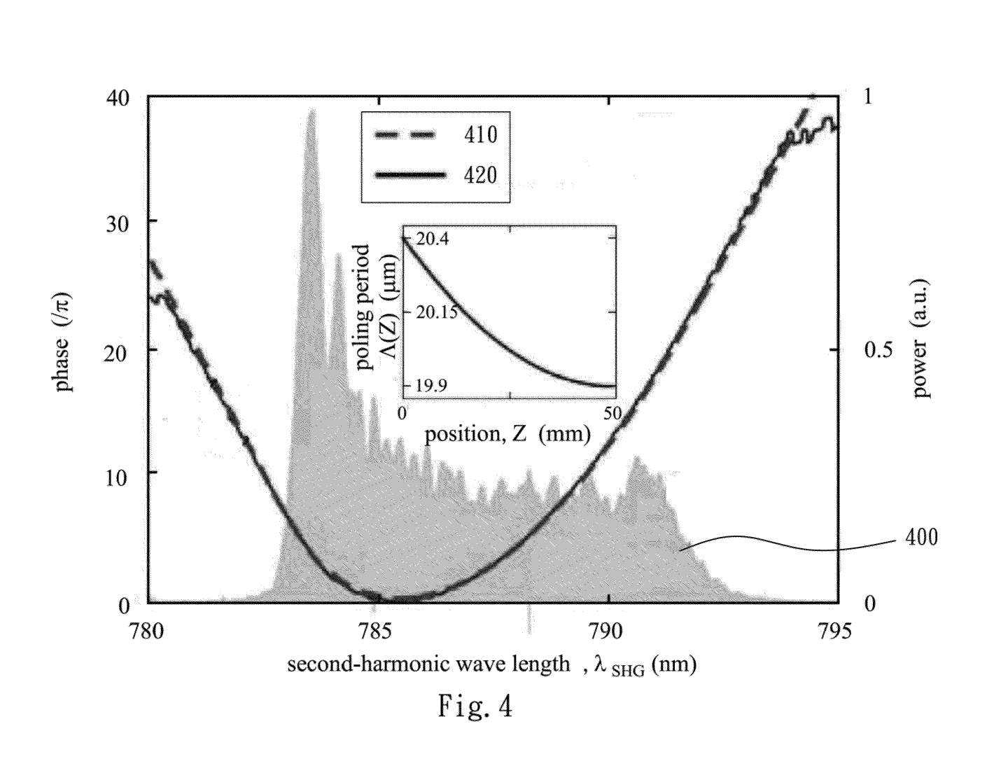

The first light 201 passes through the first nonlinear crystal 220, which can be a BBO (Barium Borate) crystal. The first light 201 is converted into the third light 203 through the first nonlinear crystal 220, wherein the third light 203 has a reference spectral phase. That is, the reference spectral phase of the third light 203 is a superposition of a nonlinear polarization spectral phase determined by the broadband light source 200 and the phase-matching spectral phase of the first nonlinear crystal 220. The thickness of the first nonlinear crystal 220 is chosen such that the resulting phase-matching spectral phase curve is nearly flat over the phase-matching bandwidth of the second (target) nonlinear crystal 230. Thinner reference crystal (the first nonlinear crystal 220) is needed if its material dispersion is stronger or the target phase-matching bandwidth is broader. In the two examples shown in FIGS. 3 and 4 (as follows), the thickness of the first nonlinear crystal 220 (reference BBO crystal) can range from 0.1 mm to 2 mm.

The second light 202 passes through the second nonlinear crystal 230. In the two examples shown in FIGS. 3 and 4, the second (target) nonlinear crystal 230 is a periodically poled MgO-doped LiNbO₃ crystal. The second light 202 is converted into the fourth light 204 through the second nonlinear crystal 230, wherein a phase-matching spectral phase of the second nonlinear crystal 230 is encoded in the phase spectrum of the forth light 204. The spectral phase of the fourth light 204 is a superposition of the nonlinear polarization spectral phase determined by the broadband light source 200 and the phase-matching spectral phase of the second nonlinear crystal 230.

Moreover, the system of FIG. 2 further includes a time delay device 270 located between the first nonlinear crystal 220 and the spectrometer 240. The third light 203 passes through the time delay device 270, so that a predetermined optical path difference between the third light 203 and the fourth light 204 is formed. Therefore, the resulting interferogram will be periodically modulated such that the desired phase-matching spectral phase of the second crystal 230 can be extracted by Fourier transform analysis.

The system can further include a second beam splitter 280 and a detector array 241, wherein the second beam splitter 280 located among the first nonlinear crystal 220, the second nonlinear crystal 230 and the spectrometer 240, and the detector array 241 such as a CCD (Charge Coupled Device) array, located on the spectrometer 240. In FIG. 2, the second beam splitter 280 is located between the time delay device 270 and the spectrometer 240. The second beam splitter 280 can combine the third light 203 and the fourth light 204, so that the third light 203 and the fourth light 204 can enter the spectrometer 240 in the same direction and interfere with each other.

The third light 203 and the fourth light 204 are combined by the beam splitter 280, wherein the third light 203 and the fourth light 204 are within the same spectrum range. The power spectrum of the combined light (the interferogram) is measured by a spectrometer 240 and a detector array 241. The difference between the spectral phase curves of the fourth light 204 and the third light 203 can be obtained by analyzing the fringe pattern of the interferogram. The common component of the nonlinear polarization spectral phase (due to the same broadband light source) in the two spectral phase curves will be canceled by the subtraction. Since the reference phase-matching spectral phase curve is nearly flat by choosing a sufficiently thin reference crystal 220, the phase difference curve is just the desired phase-matching spectral phase curve of the second (target) nonlinear crystal 230.

When the broadband light source 200 has insufficient power, the system can further include a plurality of lenses. In detail, the system of FIG. 2 includes a first lens 291, a second lens 292, a third lens 293, the fourth lens 294 and a fifth lens 295, wherein the first light 201 passes through the first lens 291, the second light 202 passes through the second lens 292, the third light 203 passes through the third lens 293, the fourth light 204 passes through the fourth lens 294, and the third light 203 and the fourth light 204 pass through the fifth lens 295 before entering the spectrometer 240.

FIG. 3 shows phase-matching spectral phases and a phase-matching power spectrum of one example. FIG. 4 shows phase-matched spectral phases and a phase-matched power spectrum of another example, wherein the poling period distribution of the second nonlinear crystal 230 (measured crystal) is a quadratic function. In the examples of FIGS. 3 and 4, the broadband light source 200 of the system of FIG. 2 for measuring a spectral phase by nonlinear optical phase-matching is obtained by passing a passively mode-locked fiber laser pulse train (50 MHz, 300 fs, 1.4 mW pluses at 1560 nm) through a 15-m-long high nonlinear fiber, and the first nonlinear crystal 220 is a 1-mm-thick 880 crystal (phase-matching wavelength between 1520 nm-1630 nm), and the second nonlinear crystal 230 is a 49.5-mm-long MgO-doped LiNbO₃ crystal with different QPM gratings.

In the examples of FIGS. 3 and 4, the wavelength range of the broadband light source 200 is between 1566 nm-1586 nm, and the spatial distributions of the poling period of the second nonlinear crystal 230 are linear and quadratic functions varying from 20.4 μm (entrance) to 19.9 μm (exit), respectively. In FIGS. 3 and 4, the power spectra 300, 400 show the conversion efficiencies at different second-harmonic wavelengths from the system of FIG. 2, respectively. The dashed line 310, 410 are the simulated phase-matching spectral phases, and the solid lines 320, 420 are experimentally measured phase-matching spectral phases from the system of FIG. 2. According to FIGS. 3 and 4, the measured phase-matching spectral phases are in good agreement with the ideal ones.

According to the foregoing embodiment and example, the advantages of the present disclosure are described as follows.

1. The spectral phase curves of the third light 203 and the fourth light 204 have the same nonlinear polarization spectral phase component, which will be canceled with each other when their difference function is retrieved by analyzing the interferogram. Therefore, the spectral phase of the broadband light source 200 is not important.

2. The system and method for measuring a phase-matching spectral phase curve by nonlinear optical spectral interferometry of the present disclosure are actual measurements. The errors due to assumed material dispersion or spatial distribution of QPM grating can thus be prevented.

3. The system and the method of the present disclosure have performed only one nonlinear wavelength conversion process, so that the system and the method of the present disclosure have high sensitivity, 4. The system and the method of the present disclosure can obtain an interferogram rapidly such as in 0.1 second in the examples of FIGS. 3 and 4) if the detector array 241 is used.

5. The system and the method of the present disclosure can be applied to laser televisions, femtosecond light pulse generators, light waveform synthesizers, and optical fiber communications.

What is claimed is:

1. A system for measuring a phase-matching spectral phase curve by nonlinear optical spectral interferometry, the system comprising:
a broadband light source;
a first beam splitter for splitting the broadband light source into a first light and a second light;
a first nonlinear crystal for converting the first light into a third light, wherein the third light has a reference spectral phase;
a second nonlinear crystal for converting the second light into a fourth light, wherein a phase-matching spectral phase of the second nonlinear crystal is encoded in a phase spectrum of the forth light; and
a spectrometer for receiving the third light and the fourth light, and providing an interferogram from an interference between the third light and the fourth light.

2. The system of claim 1, further comprising:
a time delay device located between the first nonlinear crystal and the spectrometer for forming an optical path difference between the third light and the fourth light.

3. The system of claim 1, further comprising:
a second beam splitter located among the first nonlinear crystal, the second nonlinear crystal and the spectrometer.

4. The system of claim 1, further comprising:
a polarization controller located between the broadband light source and the first beam splitter.

5. The system of claim 1, further comprising:
a collimator located between the broadband light source and the first beam splitter.

6. The system of claim 1, further comprising:
a plurality of lenses used for allowing the first light, the second light, the third light and the fourth light to pass through.

7. The system of claim 1, wherein the first nonlinear crystal BBO (Barium Borate) crystal.

8. The system of claim 1, wherein the second nonlinear crystal is an MgO-doped LiNbO₃ crystal.

9. The system of claim 1, further comprising:
a detector array located on the spectrometer.

10. A method for measuring a phase-matching spectral phase curve by nonlinear optical spectral interferometry, the method comprising:
splitting a broadband light source into a first light and a second light;
converting the first light into a third light through a first nonlinear crystal,
converting the second light into a fourth light through a second nonlinear crystal, wherein a phase-matching spectral phase of the second nonlinear crystal is encoded in a phase spectrum of the forth light; and
providing an interferogram by a spectrum from an interference between the third light and the fourth light, wherein the third light and the fourth light propagate in the same direction.
